(19) United States
(12) Patent Application Publication
(10) Pub. No.: US 2021/0339305 A1
(43) Pub. Date: Nov. 4, 2021

(54) Method for machining a bearing ring and for producing a rolling bearing

(71) Applicant: Schaeffler Technologies AG & Co. KG, Herzogenaurach (DE)

(72) Inventors: André Kuckuk, Gunzenhausen (DE); Martin Buschka, Herzogenaurach (DE)

(73) Assignee: Schaeffler Technologies AG & Co. KG, Herzogenaurach (DE)

(21) Appl. No.: 17/283,085

(22) PCT Filed: Jul. 16, 2019
(86) PCT No.: PCT/DE2019/100656

§ 371 Date: Apr. 6, 2021

(30) Foreign Application Priority Data
Oct. 22, 2018 (DE) 10 2018 126 181.0

(51) Int. Cl. B21D 53/10; F16C 19/16; F16C 33/58

(52) U.S. Cl. CPC B21D 53/10; F16C 33/58; F16C 19/16

(57) ABSTRACT

A method for machining a bearing ring of a rolling bearing includes clamping a blank for the bearing ring in a machining machine, and applying a pulsating pressure using a machining body to structure and simultaneously harden an annularly closed sealing surface of the blank. The machining body may be a spherical machining body. The method may also include removing material from the blank to produce a bearing ring track using the same clamping. The blank may be rotated during the applying a pulsating pressure step and the removing material step.

### CROSS-REFERENCE TO RELATED APPLICATIONS

This application is the United States National Phase of PCT Appln. No. PCT/DE2019/100656 filed Jul. 16, 2019, which claims priority to German Application No. DE102018126181.0 filed Oct. 22, 2018, the entire disclosures of which are incorporated by reference herein.

### TECHNICAL FIELD

The disclosure relates to a method for machining a rolling bearing ring. The disclosure further relates to a method for producing a rolling bearing as well as a rolling bearing, e.g., a wheel bearing.

### BACKGROUND

A method for the cold rolling of components is known from DE 29 20 889 C2. In this way, a rolling force pulsates with a frequency of 30 to 300 Hz. The upper limit of the pulsating rolling force should not exceed 100% of a static rolling force. The result should be a workpiece surface of the desired quality with increased fatigue strength.

DE 10 2008 032 919 A1 discloses a method for surface hardening of a component that operates with a vibrating rolling tool that can be spherical. Alternatively, the rolling tool can be cylindrical. In both cases, the rolling tool vibrates during the deep rolling of the surface to be consolidated in such a way that a hammering down is superimposed on the deep rolling of the surface.

A consolidation of the surface of a component can also be achieved by surface blasting, which is also referred to as peening. Reference is made in this context, for example, to the documents EP 1 623 794 B1, DE 10 2011 117 401 A1, U.S. Pat. No. 6,467,321 B2 and DE 10 2011 101 369 A1.

The document DE 10 2006 048 712 A1 relates to a method for ultrasonic shot blasting of transmission shafts for vehicles. This method provides for the inside of a hollow gear shaft to be machined by shot blasting. The gear shaft to be machined is attached to a sonotrode body, wherein it itself forms part of the sonotrode.

DE 10 2010 020 833 A1 discloses a method for the surface hardening of a spring. This method also works with ultrasonic shot blasting.

US 2010/0052262 A1 describes a sealing device provided for a wheel bearing, which includes an elastic sealing element and a metallic stop element. The stop element here has a surface machined by shot blasting treatment.

### SUMMARY

The disclosure provides a method for machining a rolling bearing ring in the following way:

an annular blank, provided for the production of the bearing ring, is clamped in a machining machine, for example a lathe, wherein a non-rotating arrangement of the blank is also possible as an alternative to rotating the blank,

structuring and simultaneously consolidating an annularly closed surface of the bearing ring that forms a sealing surface is effected by means of the pulsating application of pressure with a machining body.

In the case of a rotating blank, the machining body is typically part of a non-rotating machining tool. On the other hand, in the case of a blank fixed, for example, on a table, machining is possible by a machining tool which includes the machining body and which is rotated as a whole around an axis, for example, as in a multi-axis robot or a machining center, for example.

If the structuring and consolidating of the sealing surface takes place while the workpiece is rotating, at least one rolling element track of the bearing ring is machined, i.e., by turning and/or grinding in an example method in the same setting with a rotating blank, i.e., workpiece.

On the one hand, efficient and precise machining is favored by the fact that the structured surface of the bearing ring is generated in the same setting in which the machining of the bearing ring also takes place. On the other hand, no separate element, for example, in the form of a stop disk to be connected to a bearing ring or a thrust ring, is required to produce a sealing contact. Rather, within the rolling bearing, the elastic sealing element fastened to one of the bearing rings makes direct contact with the sealing surface of the other bearing ring which is machined by the application of pulsating pressure. This not only minimizes the number of parts compared to conventional solutions, but also tends to minimize the space required by the rolling bearing.

The contact seal formed by the structured surface of the bearing ring and the elastic sealing element have low friction and low susceptibility to wear at the same time having a good sealing effect. The sealing effect relates both to the retention in the rolling bearing of lubricant; i.e., grease or oil, and to keeping dirt away from the interior of the rolling bearing.

The method for producing the rolling bearing includes the following steps:

providing a bearing ring machined in the manner described and having a structured surface in the form of depressions, for example spherical depressions, and a further bearing ring,

placing a number of rolling elements between the bearing rings,

installing a seal effective between the bearing rings in such a way that it is held on the further bearing ring and comes into contact with the structured surface.

Balls as well as needles or rollers, for example cylindrical rollers or tapered rollers, can be provided as rolling elements of the rolling bearing. The rolling bearing can be designed as a single or multiple row bearing and includes two bearing rings or a larger number of bearing rings, for example three bearing rings. For example, the rolling bearing is a wheel bearing for a motor vehicle. In general, the rolling bearing includes a number of rolling elements and at least one seal are arranged between at least two bearing rings. The seal is held on one of the bearing rings and makes contact with a consolidated surface of the other bearing ring that is structured in the form of depressions. The depressions can, for example, be spherical, conical, cylindrical, or scale-shaped.

In an example embodiment, the structured surface, i.e., the sealing surface having the depressions or dents produced, has a roughness depth Rₜ of a maximum of 100 μm. This ensures a sealing effect of the seal is maintained, which runs up against the structured surface or sealing surface, and at the same time limits the friction occurring therebetween. The roughness depth Rₜ of the structured surface may be a maximum of 10 μm, for example. A roughness depth Rₜ in the range from 3 μm to 5 μm has proven itself here.

While one of the bearing rings of the rolling bearing is machined by pulsating pressure application, the other bearing ring is generally not provided with such machining. The rolling bearing can be sealed either on one side or on both sides. Each of the bearing rings can either be a one-piece or a split bearing ring.

In typical configurations, the bearing ring of the rolling bearing, which is machined by means of pulsating pressure application, is the inner ring. Either the inner ring or the outer ring can be provided as the rotating bearing ring.

The pulsating application of pressure produces an irregular plastic deformation of the surface of the rolling bearing ring. The bearing ring to be machined, initially in the form of a blank, can be clamped in a lathe, for example, for machining and pulsating pressure application. The sequence of the method steps of material-removing machining and pulsating application of pressure is not fixed in this case. In all cases, the workpiece, i.e., the bearing ring to be machined, may remain in the same setting during the two method steps.

While the bearing ring to be machined rotates, the machining tool, which brings about the pulsating application of pressure, can be moved in the radial direction or in the axial direction of the bearing ring, depending on the position of the surface to be machined. This displacement of the machining tool describes, for example, a spiral line, a helical line, or a wavy line that intersects itself multiple times on the machined surface. In any case, at the end of the machining process, depressions that were produced on the machined surface provided as a sealing surface are distributed approximately uniformly, expressed as the number of depressions per unit area.

The tool, which comes into contact with the surface of the bearing ring to be structured in a pulsating manner, can for example be designed as a ball or cylinder or barrel roller. In an example embodiment, when a ball is used as a machining tool, it can be supported by a liquid cushion that transmits the pressure pulses. The pressure pulses can be generated piezoelectrically, pneumatically, or mechanically. In cases in which the machining tool is firmly connected to a tool holder, the pressure pulses are transmitted via the tool holder. On the other hand, if the machining tool, e.g., in the form of a ball, is supported by a liquid cushion, the pressure pulses are generated by pressure fluctuations in the liquid cushion.

In all cases, the amplitude of the vibration of the machining tool can either be as large as the maximum value of the depressions or greater than the maximum depth of the deformations in the surface of the workpiece, that is to say the bearing ring. If the amplitude is limited to the maximum value of the depressions in the surface of the workpiece, permanent contact between the machining tool and the bearing ring remains during machining. If, on the other hand, amplitudes of the tool occur which are greater than the maximum value of the depressions, this means that the contact between the tool and the workpiece is regularly interrupted during machining.

### BRIEF DESCRIPTION OF THE DRAWINGS

Below, two exemplary embodiments are explained in more detail by means of a drawing. In the figures:

FIG. 1 shows a schematic representation of the machining of a surface of a bearing ring by means of pulsating application of pressure,

FIG. 2 shows a perspective view of the bearing ring machined with the method according to FIG. 1,

FIG. 3 shows a rolling bearing designed as a deep groove ball bearing including the bearing ring according to FIG. 2, and

FIG. 4 shows a section of a rolling bearing designed as a wheel bearing with a bearing ring machined according to FIG. 1.

### DETAILED DESCRIPTION

Unless otherwise stated, the following explanations relate to both exemplary embodiments. Parts or structures that correspond to each other or have basically the same effect are marked with the same reference symbols in all figures.

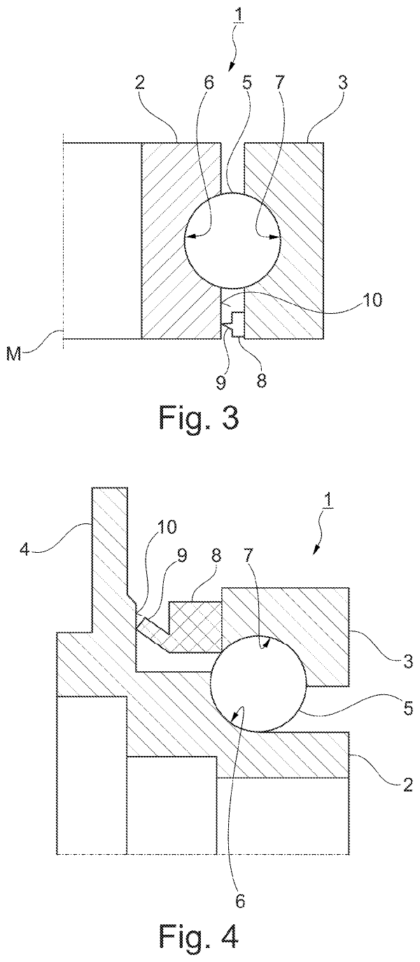

A rolling bearing identified overall with the reference number 1 is designed as a ball bearing and includes an inner ring 2 and an outer ring 3. The rolling bearing 1 shown in FIG. 3 is a deep groove ball bearing, while the rolling bearing 1, only partially sketched in FIG. 4, is a two-row angular ball bearing, namely a wheel bearing for a motor vehicle. In this case, a flange of the inner ring 2 is denoted by 4.

In both cases, balls roll as rolling elements 5 between the bearing rings 2, 3. The balls 5 can be guided in a cage (not shown). A track of the inner ring 2 coming into contact with the rolling elements 5 is denoted by 6, and a track of the outer ring 3 is denoted by 7.

A seal 8, which has a sealing lip 9, is held on the outer ring 3. The sealing lip 9 comes into contact with a surface 10 of the inner ring 2 which, in the case of FIG. 3, describes a cylinder which is concentric to the central axis M of the rolling bearing 1. In the case of FIG. 4, on the other hand, the surface 10 lies on a plane which is oriented normal to the central axis M. In both cases, the seal 8 is a contact seal. In a manner not shown, the seal 8 can have more than one sealing lip 9.

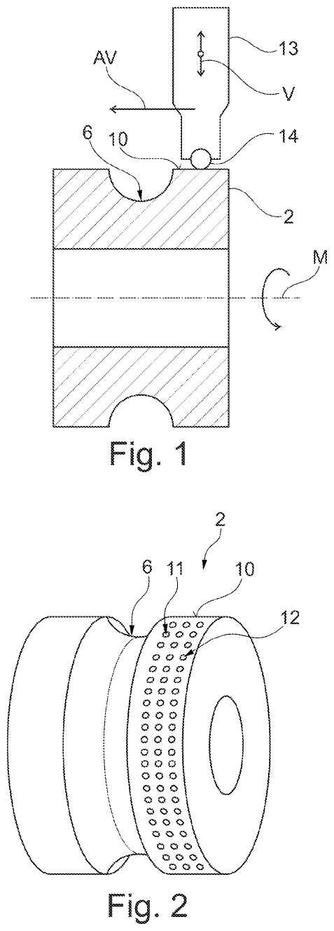

The surface 10, which is contacted by the sealing lip 9, is structured by means of a method which is illustrated in FIG. 1 and provides a surface structuring 11. This method is used in the production of the inner ring 2 of the rolling bearing 1 according to FIG. 3 as well as in the production of the inner ring 2 of the rolling bearing 1 according to FIG. 4.

To produce the inner ring 2, a blank, the basic shape of which corresponds to the shape of the later inner ring 2, is clamped into a machining machine (not shown), e.g., a lathe. During the following machining, the blank, i.e., the later inner ring 2, rotates about the central axis M thereof. The machining of the blank while it is being clamped in the machining machine includes the cutting machining of the rolling element track 6.

In the example sketched out in FIGS. 1 to 3, the rolling bearing 1 is only sealed on one side. Accordingly, the rolling bearing 1 has only a single cylindrical surface 10, Which functions as a sealing surface within the fully assembled rolling bearing 1 (FIG. 3). The surface structuring 11 of the surface 10 indicated in FIG. 2 is also given in the exemplary embodiment according to FIG. 4. The surface structuring 11 has the form of numerous depressions 12, which are distributed almost randomly on the surface 10. The roughness depth Rₜ of the structured surface 10 is in the range from 3 to 5 μm.

A tool 13, which is indicated in FIG. 1, is used to produce the depressions 12. The tool 13 is installed on the machining machine, e.g., a lathe, and includes a machining ball 14, which is generally referred to as a machining body. The machining ball 14 is rotatably arranged inside the tool 13 and is supported by a liquid cushion inside the tool 13. By generating an oscillating pressure that acts within the liquid cushion, an oscillation of the machining ball 14 is produced, which is referred to as vertical oscillation V without loss of generality. In the example according to FIG. 1, the vertical oscillation V is oriented in the radial direction with respect to the central axis M. In contrast, when machining the inner ring 2 of the rolling bearing 1 according to FIG. 4, a vertical oscillation V is to be generated, which is oriented in the axial direction with respect to the central axis M. The frequency of the vertical oscillation V is significantly higher than the speed of the inner ring 2 in both cases.

In the case of FIG. 1, an axial displacement AV of the tool 13 is superimposed on the vertical oscillation V. The axial displacement AV is also an oscillating movement. This oscillation describes a wavy line on the surface 10 along which lie the depressions 12. In the course of the multiple revolutions of the inner ring 2, multiple overlaps of this wavy line occur, so that ultimately the desired quasi-statistical distribution of the depressions 12 on the surface 10 occurs.

In a modified method, it is possible to move the machining body of the tool 13 only once in the axial direction over the surface 10, wherein the axial displacement AV in this case is much slower than in the case of the wave-shaped machining paths. The slow, one-time movement of the tool 13 theoretically generates a helical line on the surface 10. The slope of this helical line is so small that in this case too, a distribution of the depressions 12 on the surface 10 that ultimately results is uniform to a very good approximation.

To produce the surface structuring of the inner ring 2 according to FIG. 4, the tool 13 is, for example, moved slowly and evenly radially from the inside to the outside or from the outside to the inside. The depressions 12 thus generated theoretically lie on a spiral line. If, on the other hand, the tool 13 is moved at a comparatively high frequency between a first extreme point, which lies radially inward, and a second extreme point, which represents the radially outer boundary of the surface 10, then waveforms of the structuring 11 arise first which lie in a single plane, namely the plane of the surface 10. In the course of several revolutions of the inner ring 2, these waves overlap several times, in principle comparable to the exemplary embodiment according to FIG. 1, so that also in this case a high uniformity is achieved in the distribution of the depressions 12 within the surface 10.

### REFERENCE NUMERALS

1 Rolling bearing
2 Inner ring
3 Outer ring
4 Flange
5 Rolling element
6 Inner ring track
7 Outer ring track
8 Seal
9 Sealing lip
10 Surface
11 Surface structuring
12 Depression
13 Tool
14 Machining ball
AV Axial displacement
M Central axis
V Vertical oscillation

1.-10. (canceled)

11. A method for machining a bearing ring of a rolling bearing, comprising:
clamping a blank for the bearing ring in a machining machine; and
applying a pulsating pressure using a machining body to structure and simultaneously harden an annularly closed sealing surface of the blank.

12. The method of claim 11, wherein the machining body is a spherical machining body.

13. The method of claim 11, further comprising removing material from the blank to produce a bearing ring track using the same clamping, wherein the blank is rotated during the applying a pulsating pressure step and the removing material step.

14. The method of claim 11, further comprising displacing the bearing ring blank in an axial direction during the applying a pulsating pressure step.

15. The method of claim 14, wherein the machining body applies the pulsating pressure to the annularly closed sealing surface in a helical line.

16. The method of claim 14, wherein the machining body applies the pulsating pressure to the annularly closed sealing surface in a wavy line that intersects itself multiple times.

17. The method of claim 11, further comprising displacing the bearing ring blank in a radial direction during the applying a pulsating pressure step.

18. The method of claim 17, wherein the machining body applies the pulsating pressure to the annularly closed sealing surface in a spiral line.

19. The method of claim 17, wherein the machining body applies the pulsating pressure to the annularly closed sealing surface in a wavy line that intersects itself multiple times.

20. A method for producing a rolling bearing comprising:
providing the bearing ring of claim 11 with the annularly closed sealing surface comprising depressions;
providing a second bearing ring;
placing a plurality of rolling element between the bearing ring and the second bearing ring; and
installing a seal onto the second bearing ring such that is contacts the annularly closed sealing surface.

21. A rolling bearing, comprising:
a first bearing ring comprising a hardened surface having a plurality of depressions;
a second bearing ring;
a plurality of rolling elements arranged between the first bearing ring and the second bearing ring; and
a seal fixed to the second bearing ring and contacting the hardened surface.

22. The rolling bearing of claim 21 wherein the rolling bearing is a wheel bearing.
